(19) United States
(12) Patent Application Publication
(10) Pub. No.: US 2026/0195498 A1
(43) Pub. Date: Jul. 9, 2026

(54) SATELLITE DATA SELECTION AND WORKFLOW INTEGRATION

(71) Applicant: International Business Machines Corporation, Armonk, NY (US)

(72) Inventors: Vinod Anandram Valecha, Pune (IN); Jennifer Marie Hatfield, Portland, OR (US); Sarbajit Kumar Rakshit, KOLKATA (IN)

(73) Assignee: International Business Machines Corporation, Armonk, NY (US)

(21) Appl. No.: 19/010,642

(22) Filed: Jan. 6, 2025

(51) Int. Cl. G06F 30/20; G01S 19/28; G06F 111/02

(52) U.S. Cl. CPC G06F 30/20; G01S 19/28; G06F 2111/02

(57) ABSTRACT

An embodiment collects context data from an environment. The embodiment identifies a contextual scenario based on the context data collected from the environment. The embodiment identifies a plurality of relevant data sources based on the contextual scenario. The embodiment simulates a first activity using a first combination of relevant data sources The embodiment simulates the first activity using a second combination of relevant data sources. The embodiment evaluates a first set of simulation results obtained from simulating the first activity using the first combination of data sources and simulating the first activity using the second combination of data sources to determine an optimal combination of data sources based on the first set of simulation result. The embodiment initiates a data transmission based on the optimal combination of data sources to receive data from a portion of the optimal combination of data sources.

### BACKGROUND

The present invention relates generally to satellite monitoring. More particularly, the present invention relates to a method, system, and computer program for satellite data selection and workflow integration.

Artificial intelligence (AI) technology has evolved significantly over the past few years. Modern AI systems are achieving human level performance on cognitive tasks like converting speech to text, recognizing objects and images, or translating between different languages. This evolution holds promise for new and improved applications in many industries. Accordingly, AI systems may be designed for various tasks that traditional computer systems were previously incapable.

An Artificial Neural Network (ANN)—also referred to simply as a neural network—is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex. An ANN today might have upwards of billions of interconnected “neuron” processor units, though may be trained using a far fewer number of dedicated hardware processor units (e.g., GPUs). Further, ANNs can be designed to uncover relationships between previously unknown factors and accomplish tasks that were previously incapable by a human being alone.

An intelligent workflow refers to a system or set of processes that leverage artificial intelligence (AI), automation, and data analytics to optimize, streamline, and enhance decision-making in various workflows. Unlike traditional workflows, which often rely on manual input and linear task progression, intelligent workflows are adaptable, can learn from data, and can make real-time decisions based on predefined logic and patterns. Further, intelligent workflow processes can be used in various open area activities, such as agriculture, forestry, and mining, to optimize resource management and improve productivity. Examples of intelligent workflow across various industries and/or applications may include, but are not limited to, precision agriculture, forest management, mining, wildlife conservations, etc. By leveraging data, automation, and other digital technologies, open area activities can be completed more efficiently and with higher quality, leading to better outcomes for all stakeholders.

Satellites collect environmental data using a variety of instruments and sensors designed to observe the Earth's atmosphere, oceans, land, ecosystems, and other open areas. For example, one or more of these sensors may gather information across different parts of the electromagnetic spectrum, enabling a comprehensive analysis of environmental conditions. By leveraging environmental data obtained from one or more satellites, systems and organizations and further improve the effectiveness and efficiency of intelligent workflow processes.

### SUMMARY

The illustrative embodiments provide for a system and method for satellite data collection and workflow integration. An embodiment includes collecting context data from an environment. The embodiment also includes identifying, by analyzing the context data through a first neural network trained to relate contextual data to a scenario, a first contextual scenario based on the context data collected from the environment. The embodiment also includes identifying, by comparing the contextual scenario to a contextual scenario mapping defining at least one contextual scenario according to at least one relevant data source, a plurality of relevant data sources based on the contextual scenario. The embodiment also includes initiating a data transmission between the plurality of data relevant data sources and a virtual simulation environment to transmit data between the plurality of relevant data sources and the virtual simulation environment. The embodiment also includes simulating a first activity using a first combination of data sources of the plurality of relevant data source by transmitting data of the first combination of data sources to the virtual environment to cause the virtual environment to produce a first simulation result. The embodiment also includes simulating the first activity using a second combination of data sources of the plurality of relevant data source by transmitting data of the second combination of data sources to the virtual environment to cause the virtual environment to produce a second simulation result. The embodiment also includes correlating combinations of data sources to simulation results through a comparative computation between the first simulation result and the second simulation result to compute an optimal combination of data sources based on results of the comparative computation. The embodiment also includes initiating a data transmission between the optimal combination of data sources and a first component of an intelligent workflow corresponding to first activity. The embodiment also includes performing a responsive action by the first component of the intelligent workflow in response to receiving data transmitted from the optimal combination of data sources.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example processing environment in accordance with an illustrative embodiment;

FIG. 3 depicts a block diagram of an example software module for an activity simulator integrator in accordance with an illustrative embodiment;

FIG. 4 depicts a block diagram of an example process for data selection and workflow integration in accordance with an illustrative embodiment;

FIG. 5 depicts a flowchart of an example process for initiating data transmission in accordance with an illustrative embodiment; and

FIG. 6 depicts a flowchart of an example process for satellite data selection and intelligent workflow integration in accordance with an illustrative embodiment.

### DETAILED DESCRIPTION

Intelligent workflows leverage data analytics to enhance the automation of processes and optimize operational efficiency. Data analytics in intelligent workflows enables systems and organizations to extract valuable insights, patterns, and trends from large volumes of data, which can then be used to inform decision-making, streamline operations, and drive continuous improvement. In contrast, traditional workflows often rely heavily on manual tasks, which can be time-consuming and prone to human error. Further, unlike intelligent workflows, traditional workflow processes are typically static and inflexible, following a set of predefined rules that may be difficult or impossible to adjust when new information or unexpected changes arise.

Organizations and systems often use remote monitoring tools to accomplish intelligent workflows around open area activities. Remote monitoring tools encompass a diverse range of technologies and systems designed to collect, analyze, and transmit data from remote locations, enabling real-time monitoring and decision-making processes. These tools enhance the efficiency, safety, and effectiveness of open area activities by providing valuable insights and actionable information to stakeholders involved in the workflow.

An advantage of remote monitoring tools is their ability to gather data from geographically dispersed locations without the need for physical presence on-site. By utilizing sensors, cameras, drones, satellites, and other monitoring devices, systems and organizations can capture a wide array of environmental, contextual, operational, and situational data relevant to open area activities. This data may include, but is not limited to, weather conditions, terrain characteristics, equipment status, personnel location, and other critical parameters that may influence the workflow.

Moreover, remote monitoring tools enable systems and organizations to establish continuous surveillance and monitoring of open area activities, ensuring prompt detection of anomalies, deviations, emergencies, and/or any other situations that may require attention or even immediate attention. By receiving real-time data feeds and alerts from remote sensors and monitoring devices, a system or organization can proactively respond to changing conditions, mitigate risks, and optimize resource allocation to streamline the workflow process.

Furthermore, remote monitoring tools facilitate data integration and analysis, allowing organizations to derive meaningful insights and trends from the collected data. By employing data analytics, machine learning algorithms, and predictive modeling techniques, systems and organizations can identify patterns, forecast outcomes, and optimize decision-making strategies to enhance the overall performance of open area activities.

Additionally, remote monitoring tools support remote collaboration and communication among team members, stakeholders, and decision-makers involved in the intelligent workflow. By providing a centralized platform for data sharing, visualization, and reporting, these tools enable seamless coordination, information exchange, and decision synchronization across distributed teams, thereby improving operational efficiency and situational awareness in open area activities.

However, despite technological advancements in remote monitoring tools, the current landscape reveals a notable gap in the consideration of determining an optimal combination of data sources, data types, data volumes, and data transmission frequencies to establish a more effective intelligent workflow for an open area activity. An optimal combination of data sources (and data types, data volumes, and data transmission frequencies, etc.) may include a combination of data sources that has been selected in consideration of optimizing satisfaction a criteria. For example, this may include selecting a combination of data source that provides the highest successful execution likelihood in comparison to other combinations of data sources. As another example, an optimal combination of data sources may include a selection of data sources that accomplishes a specific task for the least amount of resources (e.g., computational resources, financial resources, energy resources, etc.) in comparison to other combinations of data sources. It is contemplated herein that a non-optimal combination of data sources may include a selection of data sources that may produce some result, but at a lower success rate and/or at greater resource cost than other possible candidate data source combinations. While existing tools, mechanisms, systems, and processes have significantly improved data collection and monitoring capabilities, the lack of a systematic approach to optimizing data utilization hinders the full potential of intelligent workflows in open area activities.

Embodiments of the present disclosure solve the deficiencies discussed above by providing a process (as well as a system, method, machine-readable medium, etc.) that develops an activity simulator for simulating open area activities according to various data aggregation scenarios. Embodiments of the present disclosure include simulating various combinations of data sources, types, volumes, frequencies, and other parameters to determine an optimal combination based on the satisfaction of defined criteria. This process is designed to enhance the efficiency and effectiveness of intelligent workflows in open area activities by optimizing the utilization of data resources while considering factors such as cost, bandwidth usage, power consumption, and other relevant metrics.

Further, embodiments of the present disclosure improve the functioning of the underlying technology to accomplish open area activities, in comparison to previously existing state of the art systems and processes, in at least the following ways. For example, by aggregating data sources into an optimal aggregate, redundant or unnecessary data streams are minimized, thereby reducing the processing load on the system. This allows the underlying technology to focus on the most relevant data leading to faster processing times and improved response rates for components of the system and machines involved in the performance of the open area activity. Also, optimal data aggregation considers constraints like bandwidth, power consumption, and computational resources, providing more effective and efficient utilization of these resources. Also, example embodiments of the process accommodate varying data types, frequencies, and volumes, allowing the system to dynamically adjust to changing scenarios or activity requirements, which improves the robustness of the technology, making it scalable for larger, more complex simulations and actual performance of open area activities. Also, by simulating and optimizing the data aggregation process, the system can preemptively resolve bottlenecks in data transmission and processing which greatly reduces latency and ensures real-time or near-real-time responses, which are important for intelligent workflows in dynamic open area environments. Also, selecting an optimal data aggregation helps manage data acquisition costs by avoiding overuse of expensive or unnecessary data sources and reduces hardware wear and tear by minimizing over-processing, extending the life cycle of the technology. Also, optimized data aggregation reduces the risk of conflicts or interference caused by overlapping or incompatible data streams, which prevents errors that might otherwise degrade performance. Although some technical benefits have been discussed with respect to embodiments of the present disclosure in comparison to previous state of the art systems and processes, it is understood that a person having ordinary skill in the art would recognize additional technological benefits and improvements over existing technologies provided by the present disclosure that are not explicitly stated herein.

In an embodiment, the simulation process includes generating different scenarios that represent diverse combinations of data variables, including sources, types, volumes, and transmission frequencies. These scenarios may be simulated within a computational framework that models the interactions and dependencies between the data parameters to evaluate their impact on the overall performance of the intelligent workflow.

During the simulation, the process may assess each combination of data variables based on predefined criteria that reflect the objectives and constraints of the organization or system. For example, the criteria may include minimizing the dollar cost per unit of data received, minimizing total bandwidth usage, minimizing total power consumption, maximizing data accuracy, or optimizing data relevance for decision-making processes.

As the simulation progresses, the process may iterate through different scenarios, adjusting the parameters and configurations to identify the combinations that best align with the defined criteria. By analyzing the outcomes of each simulation run, the process may determine the optimal combination of data sources, types, volumes, and transmission frequencies that maximize the satisfaction of the specified criteria while enhancing the intelligence and efficiency of the workflow.

Furthermore, the simulation process enables systems organizations to explore trade-offs between different objectives and constraints, allowing systems and organizations to make informed decisions regarding data utilization strategies. By quantitatively evaluating the performance of each combination against the defined criteria, organizations can identify opportunities for cost savings, bandwidth optimization, energy efficiency improvements, and overall workflow enhancement. By leveraging simulation techniques and data-driven analysis, systems and organizations can tailor their data strategies to meet specific objectives, improve operational efficiency, and drive better decision-making processes in dynamic and resource-constrained environments.

Embodiments of the present disclosure include determining an optimal combination of satellite data to transmit and/or integrate within an intelligent workflow, system, and/or platform. Although certain embodiments specifically reference “satellite data”, it is understood that the use of this example is non-limiting. Accordingly, embodiments of the present disclosure consider the use of other types of data as well that may be leveraged in determination of an optimal data aggregation scheme. For example, in addition to satellite data, other types of data can be used in conjunction with or in place of satellite data to enhance intelligent workflow design. This may include sensor data collected from IoT devices, drones, or on-site sensors to provide real-time information on environmental conditions, equipment status, and operational parameters. Further, weather data sourced from meteorological stations or weather APIs may be used, which offer detailed forecasts and climate information. Further, geographic information system (GIS) data may be used, which provides spatial data on terrain, land use, and infrastructure. Further, social media data may be used, which can offer insights into public sentiment, trends, and events. Even further, historical data from databases or archives can be used, which may provide additional context and enable discovery of trends over time.

As used throughout the present disclosure, the term “intelligent workflow” refers to a systematic and/or automated sequence of interconnected tasks, processes, and decisions that may leverage technologies such as artificial intelligence, machine learning, data analytics, and automation to accomplish said sequence of tasks, processes, decisions, etc. Intelligent workflows may be designed to optimize operational efficiency, enhance decision-making, and adapt to changing conditions in real time. More specifically, intelligent workflows may be designed to orchestrate and streamline complex tasks or task sequences by incorporating machine learning algorithms, predictive models, and cognitive computer capabilities to improve performance, productivity, and outcomes. Intelligent workflows characterized by their ability to learn from data, adapt to new information, anticipate future events, and dynamically adjust processes to achieve desired objectives efficiently and effectively.

Examples of responsive actions performed by a component of an intelligent workflow in an open area may include, but are not limited to, deploy sensors to measure pollutants and generate alerts if levels exceed safety thresholds, activating air filtration systems or sprinklers to control dust or particulates or contain a fire spread, automatically adjusting irrigation systems based on soil moisture data and weather forecasts, notifying farmers or landscapers of irregularities in water distribution, deploying drones equipped with multispectral cameras to assess crop health, sending alerts for areas needing pest control, fertilization, or watering, actuating a robotic harvester to identify ripe crops and perform precision picking, deploying drones or cameras to monitor animal movement and behavior in real-time, triggering alarms or deter animals from entering restricted or hazardous zones, activating wearable devices on animals to track movement, health metrics, and feeding patterns, automatically adjusting feeding schedules, or notifying handlers of abnormalities, and many more types of actions. In some embodiments, performing a responsive action may include transmitting a digital signal to a specialized machine to automatically actuate the machine upon receipt of the signal to cause the machine to perform a physical function related to the activity being performed in the open area.

As used throughout the present disclosure, the term “open area activity” refers to any task, operation, or event that takes place in an outdoor or unenclosed environment, typically characterized by a lack of physical boundaries or confined spaces. These activities may be conducted in expansive, unrestricted areas where individuals, systems, or organizations engage in various tasks, such as exploration, recreation, construction, agriculture, environmental monitoring, or emergency response.

It is contemplated herein for any type of open area activity, if an intelligent workflow is being executed to accomplish the activity, then different steps of the activity may benefit from different sets of relevant or appropriate data and information. Further, it is contemplated that a portion of this data may arise from satellites. In an embodiment, the process, based on the context of the open area activity, as well as the surrounding context (e.g., weather, criticality of the activity, etc.), embodiments of the disclosed process (and system) may dynamically integrate with different satellite data service providers so that the open area activity intelligent workflow can be executed effectively and efficiently according to a predefined criteria, as described in greater detail herein.

As used throughout the present disclosure, the term “activity context” refers to the specific set of factors, parameters, constraints, dependencies, objectives, etc. that characterize a particular activity or task. This includes factors such as task requirements, operational goals, resource availability, task dependencies, and critical variables directly associated with the execution of the activity. Understanding the activity context enables tailoring workflows, decision-making processes, and resource allocations to meet the unique demands and challenges of the activity.

As used throughout the present disclosure, the term “environment context” refers to the external conditions, surroundings, and situational factors that may influence or impact the environment in which an activity takes place. This includes variables such as weather conditions, terrain characteristics, infrastructure availability, ecosystem dynamics, and external influences that shape the operational landscape surrounding the activity area. Considering the environment context provides insights into external factors that may affect the activity, enabling systems and organizations to adapt strategies, anticipate challenges, and leverage opportunities presented by the environmental conditions to optimize performance and outcomes.

Embodiments of the present disclosure leverage the activity context and environment context in identifying the types of data that would benefit an intelligent workflow in accomplishing an activity within a particular environment according to a criteria. By analyzing the activity context, which includes parameters such as task requirements, objectives, constraints, dependencies, and critical factors directly related to the activity itself, systems and organizations can gain insights into the specific data needs for optimizing the workflow.

For example, suppose a search and rescue operation in a mountainous region. Factors such as the location of the missing person, terrain conditions, weather patterns, and available resources may be critical aspects that influence the success of the mission. By considering these activity-specific parameters, organizations can determine the types of data required to support the intelligent workflow. Accordingly, this may include real-time GPS coordinates, topographical maps, weather forecasts, satellite imagery, drone footage, and communication logs to aid in navigation, decision-making, and coordination efforts. Although embodiments of the present disclosure describe “satellite data” in some examples, it is understood that embodiments of the present disclosure may likewise consider other types of data sources as well that may be relevant for optimizing the intelligent workflow.

As used throughout the present disclosure, the term “data aggregate” refers to particular combination of data sources, types, volumes, frequencies, etc. For example, an optimal data aggregate may include weather data from a first satellite, terrain mapping from a second satellite, environmental monitoring from a third satellite. Further, it may be the case that the optimal aggregate includes receiving higher volumes/higher frequencies of weather data from a first satellite and environmental monitoring from a third satellite than terrain mapping from the second satellite, since the terrain may be less susceptible to change than, for example, the weather. It is understood that the use of this example is purely illustrative and is not intended to be limiting aspect of the disclosure.

As used throughout the present disclosure, the term “satellite” refers to an artificial object placed into orbit around a celestial body, such as a planet or a moon, for various purposes, such as, for example, communication, navigation, Earth observation, scientific research, and reconnaissance. Satellites are typically equipped with communication antennas, sensors, cameras, propulsion systems, and other instruments to perform specific functions while orbiting the celestial body. Satellites rely on the gravitational force of the celestial body to maintain their orbital trajectory and can be classified into different categories based on their orbit type, function, and size. The deployment of satellites plays a crucial role in modern technology, enabling global communication networks, weather forecasting, environmental monitoring, and a wide range of other applications.

An embodiment of the present disclosure leverages one or more satellite data sources for intelligent workflow design. Satellites can collect various types of environmental data that may be used to enhance the intelligent workflow in open area activities. Some examples of environment data that satellites may gather may include, but are not limited to: Weather Data (temperature, humidity, wind speed, precipitation patterns, etc.), Terrain Mapping Data: (e.g., topographical maps, land cover information, elevation profiles of the activity area, etc.), Vegetation Index Data (vegetation health, biomass levels, vegetation cover in the activity area, etc.), soil moisture content and soil conditions in the activity area, Oceanographic Data (sea surface temperature, ocean currents, wave heights, marine life distribution, etc.), Air Quality Data (air pollution levels, atmospheric composition, pollutant concentrations in the atmosphere, etc.), Disaster Monitoring Data (e.g., information related to natural disasters such as wildfires, floods, earthquakes, hurricanes, etc.).

Further, satellites can capture various types of data across different spectrums of the electromagnetic spectrum. The following types of satellite data includes a non-exhaustive list of some of the types of data that can be captured by satellites:

Optical Imagery: Captures visible light and near-infrared light, which is useful for monitoring land use and land cover changes, vegetation health, and water quality.

Radar Imagery: Uses microwave energy to penetrate clouds and capture data on the earth's surface, which is useful for monitoring changes in topography, urbanization, and natural disasters.

Lidar Data: Uses laser beams to measure the distance between the satellite and the earth's surface, which is useful for creating detailed 3D maps of terrain, forests, and urban areas.

Infrared Imagery: Captures heat signatures emitted by the earth's surface, which is useful for monitoring changes in temperature, vegetation health, and energy efficiency.

Atmospheric Data: Captures data on atmospheric temperature, pressure, and composition, which is useful for monitoring climate change, weather patterns, and air quality.

Magnetic Data: Captures data on the earth's magnetic field, which is useful for monitoring changes in the earth's magnetic field and predicting space weather events.

Gravity Data: Captures data on changes in the earth's gravity field, which is useful for monitoring changes in ocean currents, sea level, and the movement of tectonic plates.

Spectroscopic Data: Captures data on the chemical composition of the earth's surface and atmosphere, which is useful for monitoring changes in the environment and identifying natural resources.

Oceanographic Data: Captures data on ocean temperature, salinity, and currents, which is useful for monitoring changes in ocean circulation and predicting weather patterns.

Synthetic Aperture Radar (SAR) Data: Captures high-resolution radar imagery that can penetrate through clouds, smoke, and fog, which is useful for monitoring natural disasters and land cover changes.

Hyper-spectral Imagery: Captures data across a wide range of the electromagnetic spectrum, which is useful for monitoring changes in vegetation health and identifying minerals.

Thermal Imagery: Captures data on the temperature of the earth's surface, which is useful for monitoring changes in climate, land use, and energy efficiency.

Multi-Spectral Imagery: Captures data across multiple spectral bands, which is useful for monitoring changes in vegetation health, water quality, and urbanization.

Geodetic Data: Captures data on the earth's shape and size, which is useful for monitoring changes in the earth's crust and predicting earthquakes.

Ultraviolet Imagery: Captures data on the ultraviolet radiation emitted by the sun, which is useful for monitoring changes in the earth's ozone layer and predicting space weather events.

X-Ray Imagery: Captures data on the X-rays emitted by the sun, which is useful for monitoring solar flares and predicting space weather events.

Gamma-Ray Data: Captures data on gamma rays emitted by the earth's surface and atmosphere, which is useful for monitoring changes in the earth's radiation environment.

Radio Frequency (RF) Data: Captures data on radio signals emitted by the earth and its atmosphere, which is useful for monitoring changes in the ionosphere and predicting space weather events.

Cloud Data: Captures data on the formation and movement of clouds, which is useful for predicting weather patterns and monitoring changes in the climate.

Aerosol Data: Captures data on atmospheric aerosols, such as dust and pollutants, which is useful for monitoring air quality and predicting weather patterns.

As used throughout the present disclosure, the term “software-defined satellite” (or simply “SDS”) refers to a type of satellite that uses software to manage its onboard hardware, rather than relying exclusively on hardware-specific programming. SDS allows for greater flexibility in the operation of a satellite, since updates and changes can be made to the satellite's software, rather than requiring physical modifications to the hardware. In a traditional satellite, the satellite's hardware is designed and built to perform specific functions, such as communication or imaging. Once a satellite is launched, the satellite's functionality is largely fixed, with limited ability to update or change its capabilities. On the other hand, an SDS can be updated and reprogrammed while in orbit, allowing for more flexibility in the satellite's operation. Further, SDS is made possible through the use of software-defined radios (SDRs), which are radios that can be reconfigured through software rather than hardware modifications. SDRs allow for greater flexibility in the operation of a satellite, as they can be programmed to operate in different frequency bands, modulation schemes, and data rates.

As used throughout the present disclosure, the term “platform” refers to a software and/or or hardware environment that serves as an infrastructure for running applications, services, or other related technologies. A platform may provide a set of tools, resources, and services that enable developers to build, deploy, and manage software applications or systems. Platforms typically include operating systems, programming languages, libraries, frameworks, and APIs that facilitate the development and execution of different software applications and/or services. Example types of platforms may include, but are not limited to, operating systems platforms, cloud computing platforms, development platforms, and application platforms. In an embodiment, the platform may be tailored to specific use cases and requirements.

An embodiment includes collecting context data from an environment. An embodiment also includes identifying a contextual scenario based on the context data collected from the environment. An embodiment also includes identifying a plurality of relevant data sources based on the contextual scenario. An embodiment also includes simulating a first activity using a first combination of relevant data sources. An embodiment also includes simulating the first activity using a second combination of relevant data sources. An embodiment also includes evaluating a first set of simulation results obtained from simulating the first activity using the first combination of data sources and simulating the first activity using the second combination of data sources to determine an optimal combination of data sources based on the first set of simulation result. An embodiment also includes initiating a data transmission based on the optimal combination of data sources to receive data from a portion of the optimal combination of data sources.

Embodiments of the present disclosure leverage one or more artificial intelligence algorithms and/or machine learning models to enable the system to learn and suggest optimal data aggregations. By incorporating artificial intelligence and machine learning capabilities, the process and system can analyze vast amounts of data, identify patterns, trends, and correlations, and derive actionable insights to optimize data aggregation strategies. Artificial intelligence algorithms, such as neural networks, decision trees, or clustering algorithms, can process complex data sets and learn from historical data to predict future trends and outcomes. Machine learning models, including supervised learning, unsupervised learning, and reinforcement learning, can be trained on data to recognize patterns and make data-driven recommendations for optimal data aggregations. These algorithms and models enable the system to adapt, evolve, and continuously improve its data aggregation processes based on real-time data inputs, feedback, and performance metrics, enhancing the efficiency, effectiveness, and intelligence of the system's workflows and decision-making capabilities.

In an embodiment, one or more deep learning algorithms may be trained to learn patterns and relationships from historical data to make informed decisions about adjustments to make to previously determined optimal data aggregate. In an embodiment, at least one deep learning mechanism may be configured, trained, fine-tuned, tailored, optimized, etc. to meet a user defined objective when generating, recommending, and/or initiating an aggregate data source transmission comprising a combination of data from various data sources. The optimization mechanism may be configured to set the goals for the system, which may include, for example, defining one or more software defined satellites and initiating a data transmission that minimizes total cost transmitting data while successfully completing the activity.

In an embodiment, one or more neural networks may be trained to accomplish certain tasks, as described in greater detail herein. An embodiment includes a pre-trained neural network trained analyze environmental data to identify contextual scenarios. In an embodiment, the neural network processes inputs such as images, audio, or sensor data through multiple layers, extracting hierarchical features like edges, shapes, and textures in convolutional layers for visual data or spectral and temporal patterns for audio data. In an embodiment, the neural network uses these features to classify, cluster, or predict based on the patterns that the neural network has been trained to recognize. The model's weights, fine-tuned during training, enable the model to map raw input to high-level concepts, such as identifying objects, detecting anomalies, or inferring activities. Contextual scenario identification may involve integrating this extracted information with temporal or spatial correlations, enabling the model to generate insights, such as recognizing specific environments, predicting events, or understanding actions and activities within an open area.

In an embodiment, the process leverages system feedback to make an adjustment to a to previously determined optimal data aggregate. Examples of feedback data may include, but is not limited to, performance metrics, workflow monitoring data, interaction assessments, and other quantitative indicators that reflect the user interaction, operational efficiency and/or effectiveness of a system. System feedback provides objective measurements of system performance, user interactions, and workflow processes. By monitoring system feedback, embodiments can track key performance indicators, identify bottlenecks or inefficiencies, and optimize system functionality.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

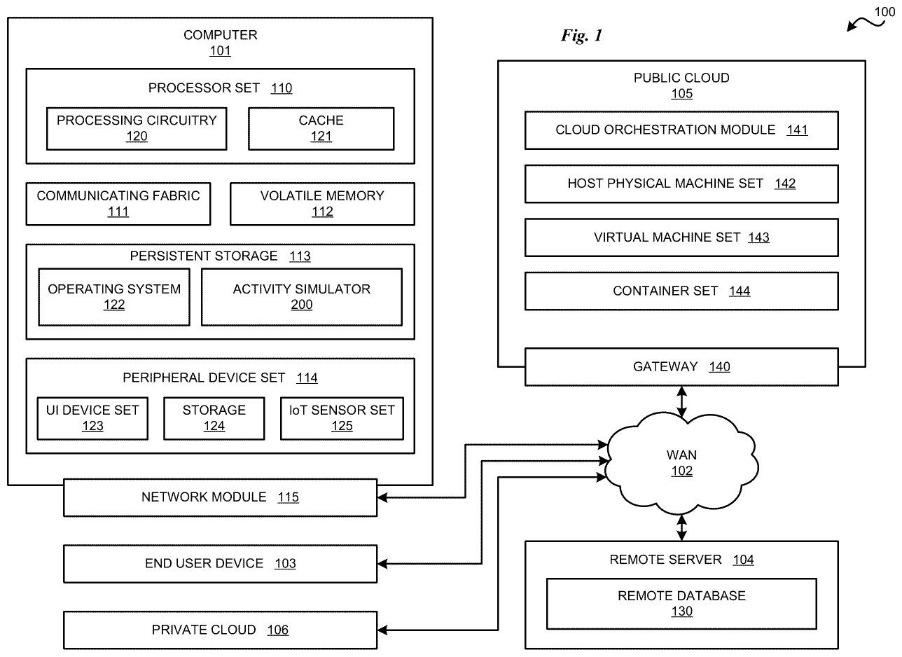

With reference to FIG. 1, this figure depicts a block diagram of a computing environment 100. Computing environment 100 contains an example of an environment for the execution of at least some of the computer code involved in performing the inventive methods, such as activity simulator 200 configured to simulate data aggregation scenarios and evaluate simulation results to determine an optimal data aggregate for accomplishing an activity. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

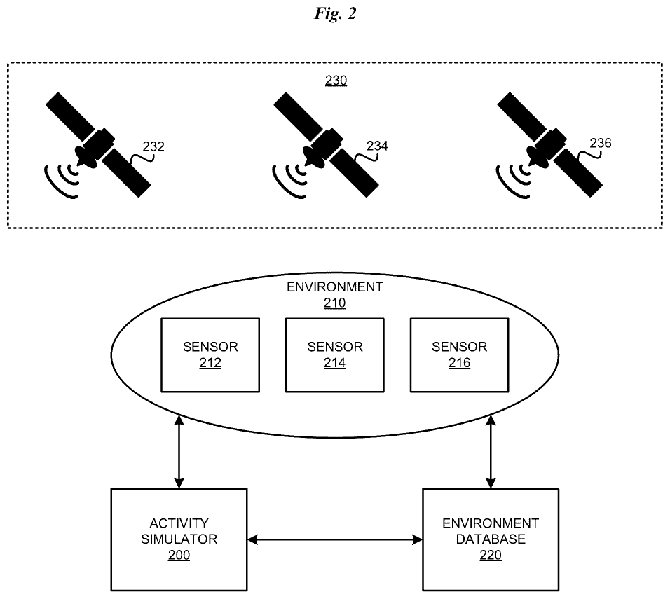

With reference to FIG. 2, this figure depicts a block diagram of an example processing environment in accordance with an illustrative embodiment. In the illustrated embodiment, the processing environment includes the activity simulator 200 of FIG. 1. In an embodiment, components of the depicted computing environment provide a system configured to generate combinations of aggregate data and analyze each combination to determine an optimal data aggregate to retrieve to accomplish an intelligent workflow within the environment 210. In an embodiment, each of the components depicted in FIG. 2 may all communicate with each other over any suitable network (e.g., the Internet).

In the illustrated embodiment, activity simulator 200 simulates various data scenarios, such that each data scenario represents a unique combination of data sources, data types, data volumes, transmission frequency, etc. Accordingly, the simulation process enables evaluating and optimizing the intelligent workflow in open area activities by exploring a wide range of data configurations and assessing their impact on operational performance and outcomes. Further, the simulator 200 evaluates the impact of different data aggregation strategies on the activity outcome, considering factors such as cost, efficiency, and performance metrics.

In an embodiment, the activity simulator 200 generates multiple data scenarios by systematically varying the parameters that define the data inputs for the intelligent workflow. For each scenario, the simulator considers different combinations of data sources, such as satellite data, sensor data, and historical records, to create a diverse set of information inputs. These data sources provide insights into the activity context, environmental conditions, and operational requirements, enabling the system to make informed decisions and adapt to changing circumstances.

In an embodiment, the simulator incorporates a variety of data types into the scenarios, including structured data (numerical values, categorical information) and unstructured data (text, images, multimedia). By simulating scenarios with different data types, the system can assess the effectiveness of processing and analyzing diverse data formats, extracting meaningful insights, and generating actionable intelligence to support decision-making processes during the activity execution.

In an embodiment, the activity simulator 200 explores variations in data volumes within each scenario, ranging from high-volume real-time data streams to low-volume periodic updates. By adjusting the data volumes, the simulator evaluates the system's capacity to handle large datasets, manage information flow efficiently, and ensure timely access to critical data points required for the intelligent workflow.

In an embodiment, the activity simulator 200 examines different transmission frequencies for data delivery, including high-frequency updates for real-time monitoring and low-frequency transmissions for periodic data collection. By simulating scenarios with varying transmission frequencies, the system can assess the impact on communication bandwidth, data latency, and resource utilization, optimizing the data transmission process to meet operational requirements and performance objectives.

In the illustrated embodiment, the environment database 220 includes a database for storing data related to the environment 210, and/or data related to one or more activities. In an embodiment, the environment database 220 stores a combination of satellite data, sensor data, real-time data, historical data, and data from various other sources (e.g., media reports, web sources, etc.). Accordingly, the environment database 220 serves as a central repository for storing a wide range of data related to the environment 210 and/or data associated with one or more activities, and may be configured for consolidating, organizing, and managing diverse datasets that are useful for supporting decision-making, analysis, and optimization of workflows within the environment 210.

In an embodiment, satellite data stored in the environment database 220 includes information collected by the first satellite 212, second satellite 214, and third satellite 216, which may include, but is not limited to, weather data, terrain mapping data, imagery, environmental monitoring data, etc. This satellite data offers insights into environmental conditions, natural phenomena, and human activities, contributing to a holistic understanding of the operational context and supporting the optimization of workflows and activities.

In an embodiment, sensor data stored in the environment database 220 comprises real-time measurements and observations captured by the first sensor 212, second sensor 214, and third sensor 216. These sensor readings may provide information on temperature, air quality, movement patterns, and other environmental parameters, enabling continuous monitoring, analysis, and response to changes in the operational environment.

In addition to satellite and sensor data, the environment database 220 houses real-time data streams that offer up-to-the-minute information on dynamic conditions, events, and trends affecting the environment and activities. Historical data stored in the database provides insights into past trends, patterns, and performance metrics, facilitating trend analysis, forecasting, and decision support for future activities. Furthermore, the environment database 220 integrates data from various external sources, such as media reports and web sources, to enrich the dataset with additional context, insights, and perspectives from external sources. By incorporating a diverse range of data inputs, the database enhances the system's capabilities for data analysis, visualization, and interpretation, enables platforms, systems, and organizations to make informed decisions, optimize workflows, and achieve operational objectives effectively and efficiently.

In an embodiment, the environment database 210 stores a mapping that defines one or more activities based on the relevant associated data sources, such as satellite data, that are deemed useful or necessary for accomplishing the activity or designing an intelligent workflow to achieve the activity objectives effectively. Accordingly, this mapping enables identifying the specific data sources required to support the activities and workflows within the environment 210.

Further, the mapping stored in environment database 220 establishes a relationship between each activity and the corresponding data sources that may be deemed required or essential for successful execution. For example, for a search and rescue operation in a mountainous region, the mapping may specify that satellite weather data, terrain mapping data, and real-time sensor readings are necessary/essential data sources needed to support the activity. By defining these dependencies, the system ensures that the necessary information is readily available to optimize decision-making and operational performance.

The mapping also outlines the data sources that are useful for designing an intelligent workflow tailored to accomplish the activity objectives efficiently. By associating specific data sources with each activity, the mapping guides the system in selecting the most relevant and valuable information inputs to enhance the workflow design process. For instance, for a wildfire monitoring activity, the mapping may indicate that satellite imagery, weather forecasts, and historical fire data are critical for designing an intelligent workflow that enables early detection, rapid response, and effective containment strategies.

In an embodiment, the activity simulator 200 leverages the mapping stored in the environment database 220 to identify the satellite data that is useful or necessary to accomplish a specific activity or design an intelligent workflow tailored to achieve the activity objectives effectively. By referencing the mapping, the activity simulator 200 can determine the data sources needed for each activity and intelligently adjust the volumes and frequencies of new incoming data to simulate the effects of different data aggregates in terms of their ability to satisfy predefined criteria.

By referencing the mapping, the simulator 200 can determine which satellite data, such as weather data, terrain mapping data, environmental monitoring data, etc. is essential, useful, relevant, etc. for supporting the activity objectives. Accordingly, this information helps the simulator 200 prioritize the relevant data sources and focus on simulating scenarios that incorporate the necessary satellite data inputs. Further, the activity simulator 200 may adjust the volumes and frequencies of new incoming data based on the mapping-defined requirements for each activity. By varying the data volumes (amount of data) and transmission frequencies (rate of data delivery) of the satellite data streams, the simulator can simulate different data aggregation scenarios to assess their impact on the intelligent workflow's performance and ability to satisfy predefined criteria.

For example, suppose if the predefined criteria include minimizing response time for emergency response activities, the activity simulator may simulate scenarios with high-frequency satellite data updates to evaluate the system's responsiveness to real-time information. Conversely, if the criteria prioritize cost efficiency, the simulator may test scenarios with lower data volumes and transmission frequencies to assess the system's ability to optimize resource utilization while maintaining operational effectiveness. By adjusting the volumes and frequencies of new incoming data streams in alignment with the mapping-defined requirements, the activity simulator 200 can simulate a range of data aggregation strategies and evaluate their effectiveness in meeting predefined criteria. This iterative process enables the system to optimize data utilization, enhance decision-making capabilities, and refine the intelligent workflow design to achieve operational objectives efficiently and effectively in diverse operational contexts.

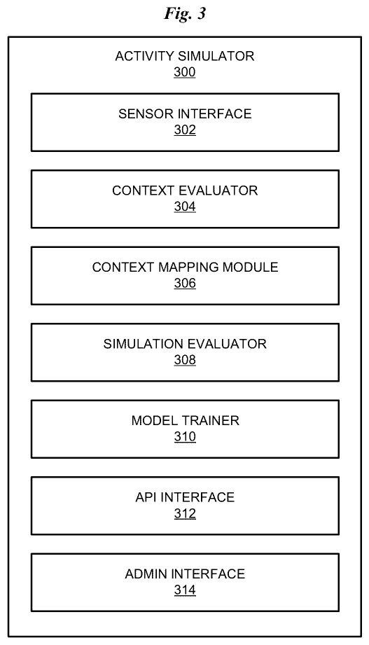

With reference to FIG. 3, this figure depicts a block diagram of an example activity simulator. In the illustrated embodiment, the activity simulator 300 includes activity simulator 200 of FIG. 2. In some embodiments, feedback analysis integrator 300 comprises specialized hardware, such as for example, an Application-Specific Integrated Circuit (ASIC) or Field-Programmable Gate Array (FPGA) for accelerated processing of specific tasks, routines, algorithms, training operations, etc. In some embodiments, the activity simulator 300 may include a combination of physical and virtualized components, as well as may be partially or entirely virtualized on a virtual machine.

In the illustrated embodiment, the activity simulator 300 is a software module that includes a plurality of other software modules, including a sensor interface 302, a context evaluator 304, a context mapping module 306, a simulation evaluator module 308, a model trainer module 310, an API interface module 312, and an admin interface module 314. In some other embodiments, the aspects of activity simulator 300 may be grouped differently in one or more other modules.

In the illustrated embodiment, the sensor interface module 302 includes a software module configured to interface with various sensors and instruments and collect real-time data related to a particular environment, and/or an open area activity occurring within a particular environment. In an embodiment, sensor interface module 302 collects real-time data from various sensors related to the open area activity, including but not limited to, information on weather conditions, terrain characteristics, and activity criticality. In an embodiment, the collected data is passed to the context evaluator module 304 for analysis.

In the illustrated embodiment, the context evaluator 304 is a software module configured to identify a context based on data collected by interface module 302. In an embodiment, the context evaluator 304 processes the incoming data from sensor interface module 302 and evaluates the contextual factors that influence the open area activity. By analyzing the data collected by the sensor interface module 302, the context evaluator module 304 can identify and understand the current operational environment in which the activity is taking place. In an embodiment, the context evaluator 304 assesses the data to determine the relevant context, such as weather patterns, terrain obstacles, or the urgency of the activity.

In the illustrated embodiment, the context mapping module 306 is a software module configured to associate one or more contexts with one or more sets of relevant data sources. Accordingly, a relevant data source may include any data source that may contain information that may be leveraged to improve an intelligent workflow process to accomplish the activity. In an embodiment, the module establishes a direct link between specific contexts identified by the system and the corresponding data sources that contain information for enhancing the intelligent workflow process to accomplish the activity effectively and efficiently. By defining these associations, the context mapping module 306 ensures that each context is matched with the appropriate data sources that hold relevant information for optimizing the workflow. These data sources may encompass a wide range of repositories, including but not limited to, databases, external APIs, historical records, real-time sensor feeds, and other sources of information that can contribute to the enhancement of the activity execution.

In an embodiment, the relevance of a data source within the context mapping framework is determined by its capacity to provide valuable insights or data points that can be leveraged to improve the intelligent workflow process. This may involve accessing data related to environmental conditions, operational constraints, resource availability, task dependencies, or any other pertinent information that can influence the decision-making and execution of the activity. By establishing these connections between contexts and relevant data sources, context mapping module 306 facilitates the seamless integration of diverse data inputs into the system. This integration ensures that the intelligent workflow process is enriched with the necessary information and insights derived from the associated data sources, thereby enhancing the system's ability to adapt, respond, and optimize its operations based on the contextual factors at play during the activity execution.

In an embodiment, the context napping module 306 is a software module configured to associate different types of satellite data for each context identified within the system. This functionality allows the module to establish specific connections between distinct contexts and the corresponding types of satellite data sources that contain relevant information essential for optimizing the intelligent workflow process associated with the activity. In an embodiment, the context mapping module 306 utilizes a mapping mechanism to link each context with the appropriate types of satellite data sources. For example, in a context related to weather conditions, the module can associate weather satellite data sources that provide real-time updates on temperature, precipitation, wind speed, and atmospheric pressure. Similarly, for a context involving terrain analysis, the module may link terrain mapping satellite data sources that offer detailed topographical information, land cover data, and elevation profiles.

In an embodiment, context mapping module 306 dynamically adjusts the associations between contexts and satellite data sources based on the evolving needs of the activity and the changing environmental conditions. By continuously updating and refining these associations, the module ensures that the system remains responsive to variations in context and can seamlessly integrate the most relevant and up-to-date satellite data sources to support the intelligent workflow process effectively.

In the illustrated embodiment, simulation evaluator module 308 is a software module configured to simulate various data aggregation scenarios and evaluate the results of the various data aggregation scenarios to determine an optimal data aggregate that satisfies a predefined criteria. Component designed to simulate a wide range of data aggregation scenarios and assess the outcomes to identify an optimal data aggregate that satisfies predefined criteria. This module is equipped with sophisticated algorithms and analytical tools that enable it to model different combinations of data sources, types, volumes, and frequencies to simulate the impact on the intelligent workflow.

During the simulation process, the simulation evaluator module 308 systematically tests different data aggregation scenarios to understand how each configuration influences the overall workflow performance. By analyzing the simulation results, the module can identify patterns, trends, and correlations that highlight the strengths and weaknesses of each data aggregation strategy. This analysis enables the module to determine which combination of data sources and parameters optimally aligns with the predefined criteria, such as maximizing productivity, minimizing costs, or enhancing decision-making processes.

Furthermore, the simulation evaluator module 308 may be configured to provide actionable insights and recommendations for refining the data aggregation strategies within the system. By evaluating the simulation results, the module can offer guidance on adjusting data volumes, transmission frequencies, or source selections to improve the overall performance of the intelligent workflow. This iterative process of simulation and evaluation allows the system to iteratively optimize its data aggregation approaches and adapt to changing conditions.

In the illustrated embodiment, the model trainer module 310 includes a software module configured to train one or more machine learning models described herein. In the illustrated embodiment, the model trainer module 310 is configured to train one or more machine learning algorithms and predictive modeling techniques to predict an optimal data aggregate for integration into an intelligent workflow. By training models on historical system data and feedback information, the model trainer module 310 can simulate different scenarios and evaluate the implications of each change on the system as a whole. This predictive analysis enables embodiments to make informed decisions about data sources priorities and strategies based on the expected impact on workflow components and/or sub-tasks within the open area activity.

In the illustrated embodiment, the application interface module 312 serves as the interface through which users and/or applications interact with activity simulator 300 and facilitates the exchange of information between the users and/or applications and the activity simulator 300. In an embodiment, the application interface module 312 is configured to interact with any or all other modules to relay data, input, queries, user feedback, and system feedback. In some embodiments, activity module 300 connects with API gateway via any suitable network 200 or combination of networks such as the Internet, etc. and uses any suitable communication protocols such as Wi-Fi, Bluetooth, etc. to connect to a platform orchestrating an intelligent workflow. The API gateway may transmit service requests received from a client interacting activity simulator 300.

In the illustrated embodiment, the administrator module 314 includes a user interface configured to allow a user having sufficient privileges to oversee the operation and management of activity simulator 300. In an embodiment, administrator module 314 controls access permissions, monitors system performance, and handles any administrative tasks related to the activity simulator 300 and/or a platform orchestrating an intelligent workflow. In an embodiment, the administrator module 314 interacts with any or all other modules. A backend administration system allows users with administrative privileges to perform various administrative tasks associated with activity simulator 300 as described herein, such as initiating a data collection and/or correlation process, a neural network training process, defining optimization goals, defining execution parameters/criteria, performing an update, adjusting parameter of a data aggregate, and any other defined settings discussed herein. In an embodiment, administrator module 314 provides a visual representation of simulations generated by activity simulator 300. In some embodiments, the visual representation manifests in the form of a textual report, a multimedia presentation, and/or a virtual reality or augmented reality experience.

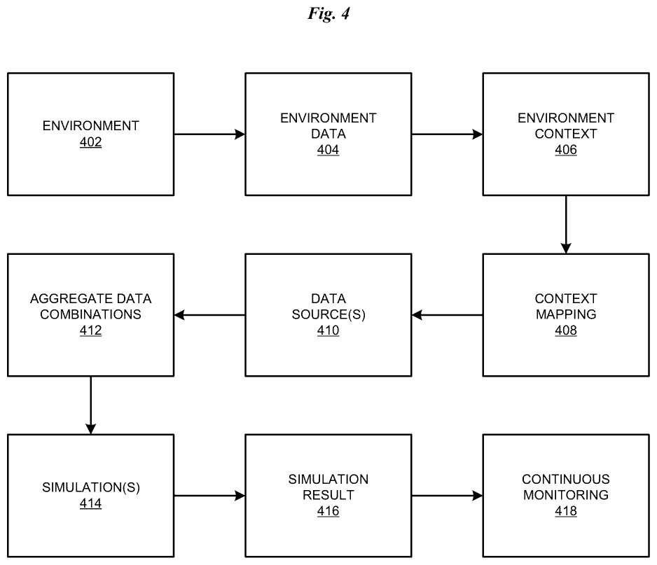

With reference to FIG. 4, this figure depicts a block diagram of an example process of data aggregation for workflow integration, in accordance with an illustrative embodiment. IW an embodiment, the activity simulator 200 of FIGS. 1 and 2 and/or the activity simulator 300 of FIG. 3 carries out the example process.

In the illustrated embodiment, block 402 depicts environment in which an activity (e.g., open area activity) occurs. In the illustrated embodiment, the process collects environment data 404 from environment 402. In the illustrated embodiment, the process determines an environment context 406 based on the environment data 404 collected from the environment 402. In the illustrated embodiment, the process creates a context mapping 408 based on the one or more environment contexts previously analyzed. Accordingly, the context mapping 408 may define various environment contexts according to relevant data sources 410. Further, based on the data sources identified using the context mapping 408, the process may create various data aggregate combinations 412.

In the illustrated embodiment, at block 414, the process performs simulations for each of the data aggregate combinations 412. Further, the simulation result(s) 416 created by the simulation(s) during block 414 include an optimal data aggregate to satisfy a defined criteria, as described in greater detail herein. In the illustrated embodiment, at block 418, the process includes continuously monitoring the performance of an activity or an intelligent workflow, and likewise may adjust parameters of the data aggregate combination to increase the effectiveness and efficiency of an intelligent workflow.

In an embodiment, performing simulations at block 414 includes systematically testing various combinations of data sources, types, volumes, frequencies, and other parameters to evaluate their impact on the performance of the intelligent workflow. By simulating different data aggregate scenarios, the system can analyze how variations in data inputs influence operational outcomes, decision-making processes, and overall efficiency in accomplishing activities. During the simulation process at block 414, the system generates simulation results 416 that represent the outcomes of the simulations conducted for each data aggregate combination. These simulation results provide insights into the effectiveness and performance of different data aggregation strategies in meeting predefined criteria, such as optimizing cost, maximizing efficiency, or achieving specific operational objectives. The simulation results help identify an optimal data aggregate that best satisfies the defined criteria, enabling the system to refine its data utilization strategies for improved workflow outcomes.

In the illustrated embodiment, at block 418, the process includes continuously monitoring the performance of an activity or an intelligent workflow. This monitoring step may include tracking key performance indicators, metrics, and outcomes related to the execution of activities and workflows within the system. Furthermore, at block 418, the process may involve adjusting parameters of the data aggregate combination based on the performance monitoring results to increase the effectiveness and efficiency of the intelligent workflow. By analyzing the performance data and feedback from ongoing activities, the system can identify areas for improvement, optimization, or adjustment in the data aggregation strategies. This adaptive approach allows the system to dynamically refine the data inputs, parameters, and configurations of the intelligent workflow to drive continuous improvement, and enable the intelligent workflow adapt to changing conditions or requirements to achieve operational success and desired outcomes effectively in dynamic environments.

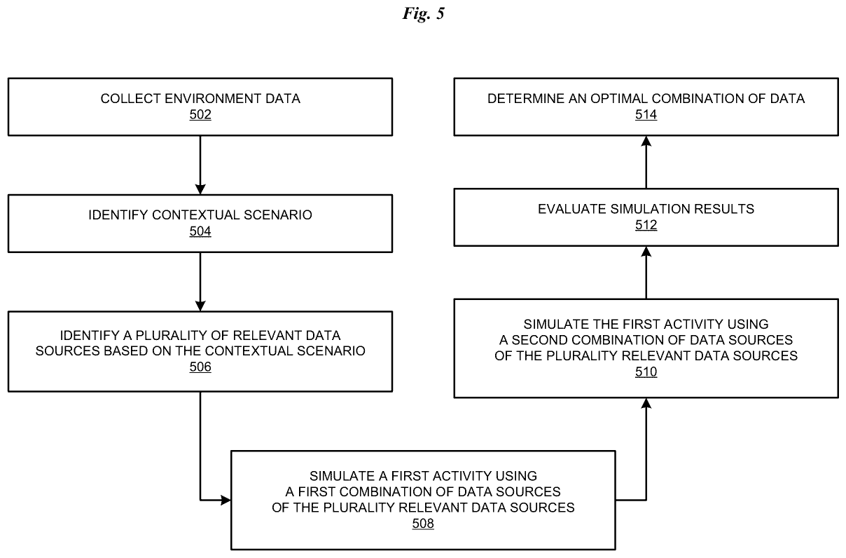

With reference to FIG. 5 this figure depicts a flowchart of an example process of selective data integration for an intelligent workflow. In an embodiment, the activity simulator 200 of FIGS. 1 and 2 and/or the activity simulator 300 of FIG. 3 carries out the process 500.

In an embodiment, at step 502, the process collects environment data. In an embodiment, at step 504, the process identifies a contextual scenario based on the environment data collected. In an embedment, at step 506, the process identifies a plurality of relevant data sources based on the contextual scenario identified. In an embodiment, at step 508, the process simulates a first activity using a first combination of data sources of the plurality of relevant data sources. In an embodiment, at step 510, the process simulates the first activity using a second combination of data sources of the plurality of relevant data sources. In an embodiment, at step 512, the process evaluates the simulation results. In an embodiment, at step 514, the process evaluates an optimal combination of data based on the evaluation of the simulation results.

Accordingly, by simulating the activity with the first data combination, the system can evaluate how well the data inputs contribute to achieving the desired outcomes and meeting predefined criteria. Further, an additional simulation activity based on a second combination enables the process to compare the outcomes and performance of the activity when using different data combinations. By testing multiple data source configurations, the process can assess the impact of varying data inputs on operational efficiency, decision-making processes, and workflow optimization. Further, the process evaluates the simulation results obtained from simulating the activity with different data combinations which may include analyzing key performance indicators, other performance metrics, outcomes, and insights derived from the simulations to assess the effectiveness and efficiency of each data combination in achieving the activity objectives. The process evaluates an optimal combination of data based on the evaluation of the simulation results. By considering the performance feedback and insights gathered from the simulations, the system can identify the data combination that best satisfies the predefined criteria, optimizes operational outcomes, and enhances the intelligent workflow design.

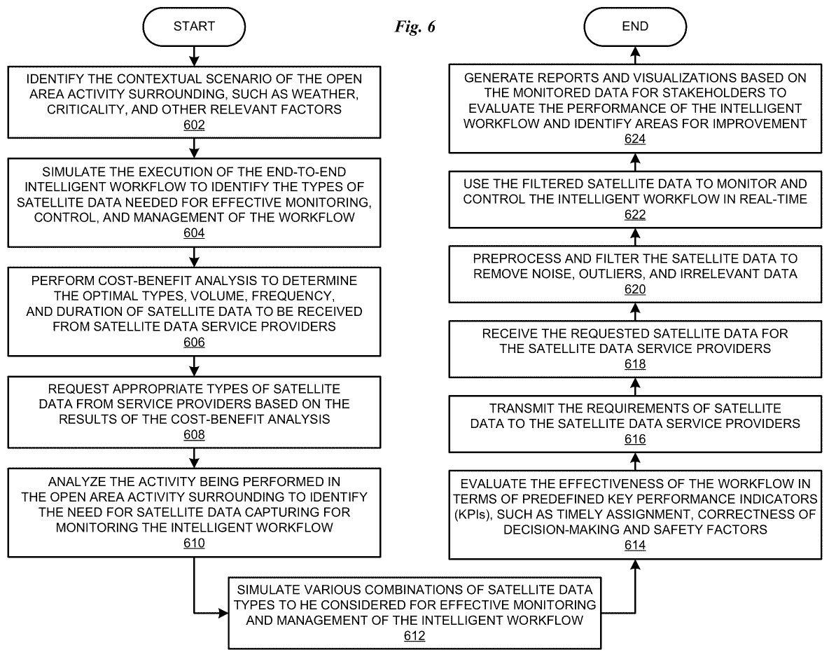

With reference to FIG. 6, this figure depicts a flowchart of an example process of satellite data selection and workflow integration. In an embodiment, the activity simulator 200 of FIGS. 1 and 2 and/or the activity simulator 300 of FIG. 3 carries out the process 600.

In an embodiment, at step 602, the process identifies an open area activity and a surrounding context corresponding to the open air activity, including factors such as weather conditions, criticality of the activity, and the specific steps of the intelligent workflow. For example, consider a forest fire fighting operation that requires real-time monitoring and mapping of the fire area to effectively allocate resources and make decisions.

In an embodiment, at step 604, the process simulates the execution of the end-to-end intelligent workflow for the identified open area activity and context. For example, the system can simulate how different types of satellite data can be used to effectively monitor and control the forest fire situation.

In an embodiment, at step 606, the process determines the types of satellite data relevant for the intelligent workflow Examples of potential relevant satellite data sources may include, but are not limited to, high-resolution imagery, weather data, GPS coordinates, and so forth. For example, the system may determine that high-resolution imagery is relevant to monitor the spread of the forest fire.

In an embodiment, at step 608, the process connects to one or more satellite data service providers to obtain the necessary satellite data. For example, the system may connect with a satellite data provider that specializes in high-resolution imagery.

In an embodiment, at step 610, the process performs a cost-benefit analysis to determine the appropriate types, volume, frequency, and duration of satellite data required for the intelligent workflow. For example, the system may determine that receiving high-resolution imagery every 5 minutes for 24 hours is the most cost-effective option.

In an embodiment, at step 612, the process requests the appropriate types, volume, frequency, and duration of satellite data from the service providers. For example, the system may request high-resolution imagery every 5 minutes for 24 hours from the satellite data provider to track the forest fire.

In an embodiment, at step 614, the process simulates different combinations of satellite data types to determine the most effective way to monitor the intelligent workflow. For example, the system can simulate how different combinations of high-resolution imagery and weather data can be used to monitor progression of the forest fire.

In an embodiment, at step 616, the process evaluates the KPIs to determine how effectively the intelligent workflow is controlled, monitored, and managed. For example, the system may evaluate the KPIs such as the time to detect a new hotspot and the accuracy of the decisions made based on the satellite data.

In an embodiment, at step 618, the process aggregates relevant data sources from different geofencing areas of the open area activity surrounding. For example, the providers may aggregate the identified relevant data sources from different forest firefighting crews.

In an embodiment, at step 620, the process creates one or more software-defined satellites to capture the relevant satellite data. For example, the process may create software-defined satellites that capture high-resolution imagery and weather data.

In an embodiment, at step 622, the process determines the optimum usage of satellite data for the intelligent workflow based on the simulation results and cost-benefit analysis. For example, the system may determine that receiving high-resolution imagery every 5 minutes and weather data every 10 minutes is the most effective and cost-efficient way to monitor the forest fire situation.

In an embodiment, at step 624, the process receives satellite data from the one or more software-defined satellites in real-time. For example, the system may receive high-resolution imagery and weather data at a specified frequency and duration.

In an embodiment, at step 626, the process preprocesses and/or filter the received satellite data to remove noise, outliers, and/or irrelevant data. This step ensures that the data used by the intelligent workflow is accurate and relevant. For example, if the intelligent workflow requires temperature and humidity data to monitor a crop field, the process may filter out any data that does not correspond to the specific location and period of the crop field.

In an embodiment, at step 628, the process monitors and controls the intelligent workflow in real-time. The process may continuously analyze the data to detect any anomalies or deviations from the expected behavior of the workflow. For example, if the intelligent workflow involves monitoring a pipeline for leaks, the process may continuously analyze satellite data to detect any changes in the pipeline's temperature, pressure, or flow rate that may indicate a leak.

In an embodiment, at step 630, the process provides an output based on results of monitoring the intelligent workflow in real time. In an embodiment, process may generate report, visualization, and/or any other informational medium based on the monitored data to enable stakeholders to evaluate the performance of the intelligent workflow and identify areas for improvement.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
collecting context data from an environment;
identifying, by analyzing the context data through a first neural network trained to relate contextual data to a scenario, a first contextual scenario based on the context data collected from the environment;
identifying, by comparing the contextual scenario to a contextual scenario mapping defining at least one contextual scenario according to at least one relevant data source, a plurality of relevant data sources based on the contextual scenario;
initiating a data transmission between the plurality of data relevant data sources and a virtual simulation environment to transmit data between the plurality of relevant data sources and the virtual simulation environment;
simulating a first activity using a first combination of data sources of the plurality of relevant data source by transmitting data of the first combination of data sources to the virtual environment to cause the virtual environment to produce a first simulation result;
simulating the first activity using a second combination of data sources of the plurality of relevant data source by transmitting data of the second combination of data sources to the virtual environment to cause the virtual environment to produce a first simulation result;
correlating combinations of data sources to simulation results through a comparative computation between the first simulation result and the second simulation result to compute an optimal combination of data sources based on results of the comparative computation;
initiating a data transmission between the optimal combination of data sources and a first component of an intelligent workflow corresponding to first activity; and
performing a responsive action by the first component of the intelligent workflow in response to receiving data transmitted from the optimal combination of data sources.

2. The computer-implemented method of claim 1, further comprising:
simulating a second activity using the first combination of data sources of the plurality of relevant data source by transmitting data of the first combination of data sources to the virtual environment to cause the virtual environment to produce a third simulation result;
simulating the second activity using the second combination of data sources of the plurality of relevant data source by transmitting data of the second combination of data sources to the virtual environment to cause the virtual environment to produce a fourth simulation result;
correlating combinations of data sources to simulation results through a comparative computation between the third simulation result and the fourth simulation result to compute an optimal combination of data sources based on results of the comparative computation.

3. The computer-implemented method of claim 1, wherein the contextual scenario comprises an activity context.

4. The computer-implemented method of claim 1, wherein the contextual scenario comprises an environmental context.

5. The computer-implemented method of claim 1, wherein the initiating the data transmission between the optimal combination of data sources and the first component of the intelligent workflow further comprises defining at least one software-defined satellite to transmit data based on the optimal combination of data sources.

6. The computer-implemented method of claim 1, wherein each data source within the optimal combination of data sources is constrained according to an individualized volume of data to be transmitted.

7. The computer-implemented method of claim 1, wherein each data source within the optimal combination of data sources is constrained according to an individualized transmission frequency of data to be transmitted.

8. The computer-implemented method of claim 1, further comprising:
continuously monitoring the intelligent workflow for one or more performance indicators; and
adjusting the optimal combination of data sources based on the one or more performance indicators.

9. The computer-implemented method of claim 9, further comprising generating a visualization based on the intelligent workflow and the one or more performance indicators.

10. A computer program product comprising one or more computer readable storage media, and program instructions collectively stored on the one or more computer readable storage media, the program instructions executable by a processor to cause the processor to perform operations comprising:
collecting context data from an environment;
identifying, by analyzing the context data through a first neural network trained to relate contextual data to a scenario, a first contextual scenario based on the context data collected from the environment;
identifying, by comparing the contextual scenario to a contextual scenario mapping defining at least one contextual scenario according to at least one relevant data source, a plurality of relevant data sources based on the contextual scenario;
initiating a data transmission between the plurality of data relevant data sources and a virtual simulation environment to transmit data between the plurality of relevant data sources and the virtual simulation environment;
simulating a first activity using a first combination of data sources of the plurality of relevant data source by transmitting data of the first combination of data sources to the virtual environment to cause the virtual environment to produce a first simulation result;
simulating the first activity using a second combination of data sources of the plurality of relevant data source by transmitting data of the second combination of data sources to the virtual environment to cause the virtual environment to produce a first simulation result;
correlating combinations of data sources to simulation results through a comparative computation between the first simulation result and the second simulation result to compute an optimal combination of data sources based on results of the comparative computation;
initiating a data transmission between the optimal combination of data sources and a first component of an intelligent workflow corresponding to first activity; and
performing a responsive action by the first component of the intelligent workflow in response to receiving data transmitted from the optimal combination of data sources.

11. The computer program product of claim 10, wherein the program instructions are stored in a computer readable storage device in a data processing system, and wherein the stored program instructions are transferred over a network from a remote data processing system.

12. The computer program product of claim 10, wherein the program instructions are stored in a computer readable storage device in a server data processing system, and wherein the program instructions are downloaded in response to a request over a network to a remote data processing system for use in the computer readable storage device associated with the remote data processing system, further comprising:
program instructions to meter use of the program instructions associated with the request; and
program instructions to generate an invoice based on the metered use.

13. The computer program product of claim 10, wherein the operations further comprise:
simulating a second activity using the first combination of data sources of the plurality of relevant data source by transmitting data of the first combination of data sources to the virtual environment to cause the virtual environment to produce a third simulation result;
simulating the second activity using the second combination of data sources of the plurality of relevant data source by transmitting data of the second combination of data sources to the virtual environment to cause the virtual environment to produce a fourth simulation result;
correlating combinations of data sources to simulation results through a comparative computation between the third simulation result and the fourth simulation result to compute an optimal combination of data sources based on results of the comparative computation.

14. The computer program product of claim 10, wherein the initiating the data transmission between the optimal combination of data sources and the first component of the intelligent workflow further comprises defining at least one software-defined satellite to transmit data based on the optimal combination of data sources.

15. The computer program product of claim 10, wherein each data source within the optimal combination of data sources is constrained according to an individualized volume of data to be transmitted.

16. The computer program product of claim 10, wherein each data source within the optimal combination of data sources is constrained according to an individualized transmission frequency of data to be transmitted.

17. A computer system comprising a processor and one or more computer readable storage media, and program instructions collectively stored on the one or more computer readable storage media, the program instructions executable by the processor to cause the processor to perform operations comprising:
collecting context data from an environment;
identifying, by analyzing the context data through a first neural network trained to relate contextual data to a scenario, a first contextual scenario based on the context data collected from the environment;
identifying, by comparing the contextual scenario to a contextual scenario mapping defining at least one contextual scenario according to at least one relevant data source, a plurality of relevant data sources based on the contextual scenario;
initiating a data transmission between the plurality of data relevant data sources and a virtual simulation environment to transmit data between the plurality of relevant data sources and the virtual simulation environment;
simulating a first activity using a first combination of data sources of the plurality of relevant data source by transmitting data of the first combination of data sources to the virtual environment to cause the virtual environment to produce a first simulation result;
simulating the first activity using a second combination of data sources of the plurality of relevant data source by transmitting data of the second combination of data sources to the virtual environment to cause the virtual environment to produce a first simulation result;
correlating combinations of data sources to simulation results through a comparative computation between the first simulation result and the second simulation result to compute an optimal combination of data sources based on results of the comparative computation;
initiating a data transmission between the optimal combination of data sources and a first component of an intelligent workflow corresponding to first activity; and
performing a responsive action by the first component of the intelligent workflow in response to receiving data transmitted from the optimal combination of data sources.

18. The computer system of claim 17, further comprising:
simulating a second activity using the first combination of data sources of the plurality of relevant data source by transmitting data of the first combination of data sources to the virtual environment to cause the virtual environment to produce a third simulation result;
simulating the second activity using the second combination of data sources of the plurality of relevant data source by transmitting data of the second combination of data sources to the virtual environment to cause the virtual environment to produce a fourth simulation result;
correlating combinations of data sources to simulation results through a comparative computation between the third simulation result and the fourth simulation result to compute an optimal combination of data sources based on results of the comparative computation.

19. The computer system of claim 17, wherein each data source within the optimal combination of data sources is constrained according to an individualized volume of data to be transmitted.

20. The computer system of claim 17, wherein each data source within the optimal combination of data sources is constrained according to an individualized transmission frequency of data to be transmitted.
